(19) United States
(12) Patent Application Publication
(10) Pub. No.: US 2026/0321441 A1
(43) Pub. Date: Oct. 15, 2026

(54) SOLENOID PLASMA CONTROL

(71) Applicant: Tokamak Energy Ltd, Milton, Abingdon, Oxfordshire (GB)

(72) Inventors: Yuichi Takase, Milton, Abingdon (GB); Matthew Bristow, Milton, Abingdon (GB)

(21) Appl. No.: 19/485,136

(22) PCT Filed: May 16, 2024
(86) PCT No.: PCT/EP2024/063614

§ 371 Date: Nov. 17, 2025

(30) Foreign Application Priority Data
May 23, 2023 (GB) 2307715.9

(51) Int. Cl. G21B 1/05

(52) U.S. Cl. CPC G21B 1/057

(57) ABSTRACT

A method of operating a tokamak. The tokamak includes a toroidal plasma chamber; poloidal and toroidal field coils configured to confine a plasma within the plasma chamber; a solenoid located in the centre of the torus, the solenoid including high temperature superconducting material; and a current drive system other than the solenoid, configured to ramp-up a plasma current in a plasma confined within the plasma chamber. A plasma is initiated in the toroidal plasma chamber. A plasma current is ramped up in the plasma using the current drive system until the plasma current reaches an operating point, wherein when the plasma current reaches the operating point, a current in the solenoid is smaller than a maximum operating current of the solenoid.

### FIELD OF THE INVENTION

The present invention relates to plasma control in a tokamak plasma chamber.

### BACKGROUND

A tokamak is a device which uses high magnetic fields to confine plasma within a toroidal chamber, through a combination of toroidal and poloidal field coils. The magnetic field interacts with currents in the plasma (the “plasma current”) to keep the plasma constrained within the toroidal chamber, and prevent contact with the walls. In this manner, tokamaks are particularly suitable to high energy plasma confinement, such as required for fusion.

One particular design of tokamak is a “spherical tokamak”, where rather than the ring-donut-like shape of a conventional tokamak, the toroidal chamber is shaped more like a cored apple—with a broadly spherical profile, and a central column which is small compared to the radius of the plasma chamber. The ratio of the major radius of the plasma (i.e. the radius from the centre of the central column to the geometric centre of the plasma) to the minor radius (i.e. the radius of the cross-section of the plasma, from the geometric centre of the plasma to the outside of the plasma envelope in the equatorial plane of the tokamak) is called the “aspect ratio”. For a spherical tokamak it is important to minimise this aspect ratio where possible. This is because the upper limit of the plasma energy that can be confined in a spherical tokamak has a strong negative dependence on the aspect ratio—i.e. the lower the aspect ratio, the higher the energy of a plasma that can be confined with a given magnetic field, or conversely the lower magnetic field is required to confine a given plasma energy. The minimum aspect ratio possible will depend upon engineering constraints and the theoretical minimum of one is not possible in practice because of the need to place magnetic coils to confine the plasma. Experimental spherical tokamaks for confining plasma may have aspect ratios as low as 1.2 to 1.5, while larger spherical tokamaks suitable for producing sustained fusion reactions may not be able to achieve aspect ratios below 1.9 to 2.0.

Magnetic confinement in a tokamak relies in part on the plasma current, and as such this plasma current must be initiated when the plasma is formed, and maintained during operation of the tokamak. There are four major ways to drive the plasma current:
Externally injected power (“external current drive”), via the use of electromagnetic waves which resonate with the plasma particles (RF current drive) and/or the injection of neutral atoms (neutral-beam current drive)
At high plasma pressures, the plasma will tend to spontaneously drive a plasma current (a “bootstrap current”)
As the plasma energy increases, the plasma will attempt to expand-resisting this expansion by compressing the plasma with the poloidal magnetic fields of the tokamak will drive the plasma current (vertical field drive)
A solenoid located on the central column of the tokamak can be used to generate a time-varying magnetic flux, which will drive the plasma current (solenoid drive).

RF current drive systems typically comprise of a high-power RF source, a transmission line to transport the RF power to the plasma, an antenna to launch the RF power into the plasma, and a matching network to match the impedance of antenna (in the presence of plasma) to the transmission line impedance. RF electromagnetic waves are introduced into the plasma so that they propagate within the plasma in the direction of the desired plasma current, causing the electric field of the waves to accelerate the charged particles in the plasma. The specific design of the RF current drive system can vary depending on the requirements of the tokamak, such as the plasma density, temperature, and magnetic field configuration.

In neutral beam current drive, high energy neutral atoms are injected into the plasma. Through collisions with the electrons in the plasma, the neutral beam becomes ionised and creates an ion current. Electrons try to cancel the ion current, but because of incomplete cancellation, a net plasma current remains.

The bootstrap current occurs where the plasma pressure is greater in the core of the plasma envelope than at the edge. This difference in pressure will spontaneously drive a toroidal current in a plasma. Tokamaks with a low aspect ratio during the main plasma pulse, e.g. less than 2.5, exhibit significantly higher bootstrap currents (as a proportion of the overall plasma current) than conventional tokamaks.

Vertical field drive occurs when the vertical field applied to the plasma is increased in response to the plasma energy increase to maintain the plasma equilibrium. The increase of the vertical field results in an increase in the plasma current. This is usually done with the outboard poloidal field coils, i.e. those coils which are outside of the major radius of the plasma.

Solenoid drive relies on the current in the solenoid varying in a given direction. An appropriate change in the solenoid magnetic flux linked to the plasma increases the plasma current. For example, to increase a positive plasma current the solenoid needs to be decreased to a lower solenoid current (i.e. the change in magnetic flux is negative). While it is an efficient way to drive the plasma current, the length of the pulse that can be driven is limited by the maximum magnetic flux that can be generated by the solenoid, so it is only considered suitable for short plasma pulses.

A primer on these drive systems can be found in many standard references, e.g. on the online edition of the Encyclopedia Britannica (www.britannica.com/technology/fusion-reactor/Principles-of-magnetic-confinement).

### SUMMARY

According to a first aspect, there is provided a method of operating a tokamak. The tokamak comprises a toroidal plasma chamber; poloidal and toroidal field coils configured to confine a plasma within the plasma chamber; a solenoid located in the centre of the torus, the solenoid comprising high temperature superconducting material; and a current drive system other than the solenoid, configured to ramp-up a plasma current in a plasma confined within the plasma chamber. A plasma is initiated in the toroidal plasma chamber. A plasma current is ramped up in the plasma using the current drive system until the plasma current reaches an operating point, wherein when the plasma current reaches the operating point, a current in the solenoid is smaller than a maximum operating current of the solenoid. After the plasma current reaches the operating point, the solenoid is used to control the plasma current; control the position of the plasma; and/or control the shape of the plasma. The plasma has an aspect ratio of less than 2.5.

According to a second aspect, there is provided a tokamak. The tokamak comprises a toroidal plasma chamber, poloidal and toroidal field coils, a solenoid, a current drive system other than the solenoid, and a controller. The poloidal and toroidal field coils are configured to confine a plasma within the plasma chamber. The solenoid is located in the centre of the torus, the solenoid comprises high temperature superconducting material. The current drive system is configured to ramp-up a plasma current in a plasma confined within the plasma chamber. The controller is configured to:
initiate a plasma in the toroidal plasma chamber;
ramp up a plasma current using the current drive system until the plasma current reaches an operating point, wherein when the plasma current reaches the operating point, a current in the solenoid is smaller than a maximum operating current of the solenoid;
after the plasma current reaches the operating point, use the solenoid to:
   control the plasma current;
   control the position of the plasma; and/or
   control the shape of the plasma;
maintain the plasma at an aspect ratio of less than 2.5.

Further embodiments are presented in claim 2 et seq.

### BRIEF DESCRIPTION OF THE DRAWINGS

FIG. 1 is a cross section of an exemplary tokamak;

FIG. 2 is a flowchart of a method of operating the tokamak of FIG. 1; and

FIG. 3 is a graph showing various properties of the tokamak of FIG. 1 before, during, and after a plasma pulse.

### DETAILED DESCRIPTION

In plasma physics applications, there is a need to study plasmas at high energies, to study plasma properties and phenomena at temperatures relevant to fusion operation. Current devices have mainly focussed on short-pulse operation (where the plasma is maintained for typically 10 seconds or less), or long pulse operation at low plasma density, plasma current and/or plasma temperature. Increasingly, there is a need to study high energy plasmas in long-pulse operations lasting at least several minutes and ideally hours to weeks, which cannot be achieved in current tokamaks.

One major issue with long-pulse operation is plasma control. In one aspect of this, the plasma current must be kept close to a desired operating point, which requires two kinds of control. Firstly, the plasma current must be continually replenished to counteract resistive losses in the plasma (this will be partly driven by the plasma's own “bootstrap current”, but some external input is generally required), and secondly finer control must be used to keep the plasma current at the operating point and prevent feedback loops which would cause the plasma to disrupt.

In simple terms, if the plasma current decreases from the operating point, then the confinement time of the plasma will decrease. This causes a decrease in plasma temperature, and hence the bootstrap current of the plasma, resulting in further decreases to the plasma current in a continuous negative feedback loop. Restoring the plasma current to the desired operating point in such a situation is done by a solenoid, as this allows the plasma current to be quickly returned to the operating point (whereas other methods of ramping plasma current such as RF current drive will generally be too slow to counteract the feedback loop).

The ability of a tokamak to control the plasma state with a solenoid depends on the ability to appropriately vary the current in the solenoid. If a required control input would cause the magnitude of the current to exceed the tolerances of the solenoid, then that control input is not possible and this will usually result in an undesirable decrease of the plasma current and/or the movement of the plasma (unless an alternative control method is available). This is particularly an issue where the solenoid is made of a resistive (i.e. non-superconducting) material, as in that case the current in the solenoid cannot deviate from zero for a significant time due to resistive heating-as such, if multiple control inputs are required which would push the current in the same direction (i.e. more positive or more negative), this can result in the solenoid operating continuously at significant current, resulting in excess heat generation.

The solenoid may also be used to control the position and/or shape of the plasma. For example, the solenoid can be used to control the inboard gap (i.e. the gap between the plasma and the inner boundary of the plasma chamber), high-field side leg, triangularity and/or elongation of the plasma. Changing the current in the solenoid changes the magnetic field which is experienced by the plasma (e.g. magnetic field experienced across a cross-section of the plasma), changing the plasma shape and/or plasma position. For example, reducing the solenoid current (without making adjustments to other plasma control inputs) would have the effect of changing the magnetic field experienced by the plasma, driving an increase in plasma current and an increase in the inboard gap (depending on the geometry and direction of the plasma current relative to the solenoid current).

The ability to change and control the magnetic field locally is improved when the solenoid is segmented into multiple independently controllable parts (segments) in the vertical direction (i.e. along the central axis of the solenoid), each segment having its own current source. This improves the control of the plasma position and/or shape.

Poloidal field coils can be used in combination with the solenoid to improve the simultaneous control of plasma current, plasma shape and plasma position. In an embodiment in which it is not desirable to change the shape and/or position of the plasma when using the solenoid to control the plasma current, this can be counteracted by using the poloidal field coils in a manner which is well-known in the art. Additionally, when the solenoid is used to control the shape and/or position of the plasma, control of the plasma current may be maintained using the other current drive methods preciously described.

One way to mitigate this is by the use of a superconducting solenoid, which can be started at a large positive current, ramped to a moderate negative current when initiating the plasma and ramping up the plasma current, and then held at that current to allow some ability to further manipulate the plasma using the leeway between the moderate negative current and the maximum current that can be carried by the solenoid. However, doing this would be impractical in a tokamak with an aspect ratio less than 2.5, as the solenoid would have to be large to ensure that a sufficient change in magnetic field occurs to drive the plasma current during that initial ramp-up of the plasma current, while still allowing some headroom in the current in the solenoid. This large solenoid would require a significant amount of space in the central column, and the relatively low aspect ratio means this is unlikely to be possible without significant compromises in other components within the central column.

Instead, the present disclosure proposes a hybrid approach, where non-solenoid systems are used instead of or in addition to the solenoid during the initial plasma current ramp up, and the solenoid is used for plasma control during the stable portion of the plasma pulse, and is made from superconducting material.

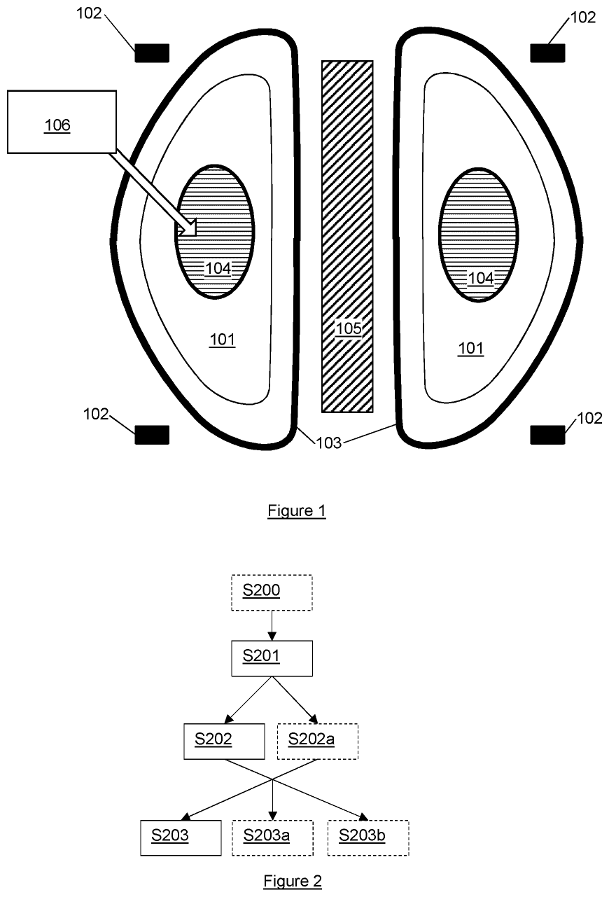

As shown schematically in cross section in FIG. 1, a tokamak is used which comprises a toroidal plasma chamber 101, poloidal field (PF) coils 102 and toroidal field (TF) coils 103 for confining a plasma 104 within the chamber 101, a central solenoid 105, and a current drive system 106 other than the solenoid. The tokamak may additionally comprise a controller (not shown) configured to perform the methods described herein.

The aspect ratio of the plasma during operation of the tokamak (i.e. during the pulse, once the plasma has reached the desired operating current) is less than 2.5, more preferably less than 2.3, more preferably less than 2. Engineering limits may mean the aspect ratio is larger than 1.2, larger than 1.5 or larger than 1.9.

The current drive system may be, for example, an RF current drive system, a vertical field current drive system (which includes some of the PF coils), or a neutral beam injection current drive system as described in the background, or any other suitable non-solenoid system for driving plasma current.

The central solenoid comprises a high temperature superconductor, HTS, as this allows it to carry a significant current for the duration of the plasma pulse without overheating due to its resistance. High temperature superconductors are particularly suitable here, as less cooling will be required in the central column to maintain them in a superconducting state, and their higher current densities allow for greater control of the plasma. While the central solenoid is shown as wound inward of the TF coils, it may be wound around the central column portion of the TF coils, i.e. between the TF coils and the plasma chamber.

The solenoid will have a maximum operating current, i.e. a maximum current (positive or negative) which it is designed to carry. This may be set, for example, based on resistive losses in non-superconducting components, by the capacity of a power supply, or by the critical current in superconducting components, with an appropriate safety margin. The purpose of the hybrid approach is to ensure that once the plasma current is ramped up to the operating plasma current, there is available margin between the solenoid current and the maximum (positive or negative) operating current of the solenoid, which can be used to provide control of the plasma current and/or shape of the plasma during the pulse.

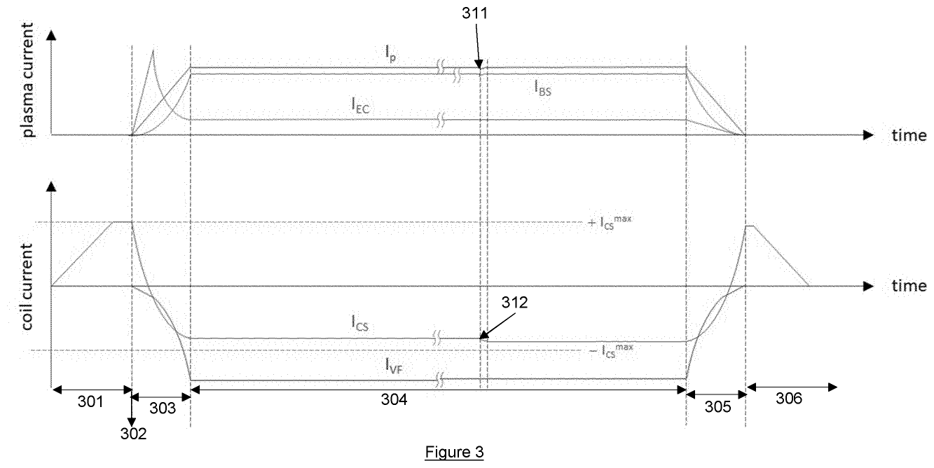

FIG. 2 shows a flowchart of a method of operating the tokamak of FIG. 1, with steps in dotted boxes being optional.

In step S200, the solenoid is optionally initially charged to an initial current, as will be described in more detail later.

In step S201, the plasma is initiated by any suitable means as known in the art.

In step S202, after initiation of a plasma in the tokamak, the plasma current is ramped up to an operating plasma current using the (non-solenoid) current drive system. This may be done using the current drive system alone, or may be done in combination with current drive from the solenoid (S202a), but either way once the ramp-up is complete the solenoid is left with a current which is smaller (i.e. a lower magnitude) than the maximum operating current.

In step S203, the plasma current is then maintained at the operating plasma current during the pulse by the solenoid. This may include using the current drive system for coarse control (S203a, e.g. injecting a consistent amount of power via the current drive to counter resistive losses) and using the solenoid for fine control (e.g. operating the solenoid in a feedback loop, where the plasma current is monitored and, in response to detecting a deviation from the operating point, the solenoid current is altered to counteract that deviation). In this scheme the maximum operating current of the solenoid is unlikely to be a limitation on the length of the plasma pulse-as deviations from the operating current after the effects of the coarse control will likely be broadly uniform in direction on average. Alternatively, the solenoid may be used for both coarse (S203b) and fine control, though this will result in the solenoid reaching its maximum operating current more quickly, as the coarse control will cause the solenoid current to increase more in the direction which is required to counter resistive losses.

Prior to igniting the plasma, in step S200, the solenoid may initially be ramped to an initial current. This may be a current opposite in direction to the direction of current change required to ramp-up the plasma current, i.e. so that if the solenoid is used to ramp-up the plasma current or for control of the plasma current during the pulse, then the solenoid current initially reduces to zero, and then rises in the opposite direction. This allows for a larger change of current in the solenoid during the plasma current ramp up and the pulse than would be possible if it were at zero current at the point of plasma initiation.

The upper part of FIG. 3 shows a graph of the plasma current, plus contributions from the bootstrap current and external current drive, for an exemplary plasma pulse. The bottom part of FIG. 3 shows a graph of the current in the solenoid and the vertical field coils, on the same time scale. In this example the “current drive system” 106 of FIG. 1 comprises both an external current drive, e.g. RF current drive, and vertical field drive.

In detail, during the initial period 301, the solenoid current I_{CS} is charged from an initial current of zero to a its maximum allowed positive current +I_{CS}^{MAX} S200 (in this example, a change from positive current towards negative current will ramp up the plasma current). At time 302, the plasma is initiated S201, and then during period 303 the plasma current Iₚ is ramped up by a combination of the external (injection) current drive I_{EC}, ramping the vertical field I_{VF} to a negative current S202, and ramping the central solenoid to a moderate negative current (e.g. to negative 80% of the maximum negative operating current −I_{CS}^{MAX} of the central solenoid) S202a.

As FIG. 3 shows an illustration of the currents in a tokamak with an aspect ratio less than 2.5, the bootstrap current I_{BS} is close to the plasma current Iₚ. In this example, during the pulse 304, the external current drive I_{EC} is maintained to counteract resistive losses S203a, and the vertical field is held constant during the pulse. During the pulse, the central solenoid is used for fine control of the plasma S203. When a negative deviation 311 of the plasma current from the operating point is detected, the solenoid current is driven more negative 312 in order to positively drive the plasma current and counteract the deviation 311. If the deviation were instead positive, then the solenoid current would be driven more positive in order to negatively drive the plasma current.

Following the pulse, in period 305, the external current drive is tapered off, the vertical field is ramped back to zero, and the solenoid is ramped back to the initial current in order to ramp down the plasma current and safely extinguish the plasma without disrupting it. Finally, in period 306, following extinction of the plasma, the solenoid is ramped back down to zero current.

The overall effect is to allow for the use of the solenoid for plasma control, without requiring a large solenoid which can handle the full ramp-up of plasma current while still keeping some current carrying capacity in reserve for use in controlling the plasma.

1. A method of operating a tokamak, wherein the tokamak comprises:
a toroidal plasma chamber;
poloidal and toroidal field coils configured to confine a plasma within the plasma chamber;
a solenoid located in a centre of a torus, the solenoid comprising high temperature superconducting material;
a current drive system other than the solenoid, configured to ramp-up a plasma current in a plasma confined within the plasma chamber;
the method comprising:
initiating a plasma in the toroidal plasma chamber;
ramping up a plasma current in the plasma using the current drive system until the plasma current reaches an operating point, wherein when the plasma current reaches the operating point, a current in the solenoid is smaller than a maximum operating current of the solenoid;
after the plasma current reaches the operating point, using the solenoid to:
control the plasma current;
control a position of the plasma; and/or
control a shape of the plasma;
wherein the plasma has an aspect ratio of less than 2.5.

2. The method according to claim 1, wherein the step of ramping up a plasma current until the plasma current reaches an operating point comprises driving the plasma current using the current drive system and the solenoid.

3. The method according to claim 1, wherein the step of ramping up a plasma current until the plasma current reaches an operating point comprises driving the plasma current using the current drive system and does not comprise driving the plasma current using the solenoid.

4. The method according to claim 1, wherein the plasma has an aspect ratio of less than or equal to 2.3.

5. The method according to claim 1, and comprising, prior to initiating the plasma in the toroidal plasma chamber, ramping the solenoid to an initial current.

6. The method according to claim 1, wherein the current drive system comprises a radio frequency (RF), current drive system or a neutral beam injection system.

7. The method according to claim 1, wherein the current drive system comprises a subset of the poloidal field coils, said subset being configured to drive the plasma current by increasing a vertical field on the plasma.

8. The method according to claim 7, wherein each poloidal field coil of the subset of the poloidal field coils is located radially outwards of a major radius of the plasma.

9. The method according to claim 1, wherein maintaining the plasma current at the operating point using the solenoid comprises:
monitoring the plasma current;
determining a variation of the plasma current from the operating point; and
altering the current in the solenoid to counteract the variation.

10. A tokamak comprising:
a toroidal plasma chamber;
poloidal and toroidal field coils configured to confine a plasma within the plasma chamber;
a solenoid located in a centre of a torus, the solenoid comprising high temperature superconducting material;
a current drive system other than the solenoid, configured to ramp-up a plasma current in a plasma confined within the plasma chamber;
a controller configured to:
initiate a plasma in the toroidal plasma chamber;
ramp up a plasma current using the current drive system until the plasma current reaches an operating point, wherein when the plasma current reaches the operating point, a current in the solenoid is smaller than a maximum operating current of the solenoid;
after the plasma current reaches the operating point, use the solenoid to:
control the plasma current;
control a position of the plasma; and/or
control a shape of the plasma;
maintain the plasma at an aspect ratio of less than 2.5.

11. The tokamak according to claim 10, wherein the controller is configured to maintain the plasma at an aspect ratio of less than 2.3.
